(19) United States
(12) Patent Application Publication
(10) Pub. No.: US 2025/0010818 A1
(43) Pub. Date: Jan. 9, 2025

(54) PRECIPITATION LEVEL ESTIMATION SYSTEM AND STORAGE MEDIUM

(71) Applicant: Toyota Jidosha Kabushiki Kaisha, Toyota-shi (JP)

(72) Inventor: Satoshi UNO, Mishima-shi (JP)

(73) Assignee: Toyota Jidosha Kabushiki Kaisha, Toyota-shi (JP)

(21) Appl. No.: 18/672,216

(22) Filed: May 23, 2024

(30) Foreign Application Priority Data
Jul. 4, 2023 (JP) 2023-109917

(51) Int. Cl. B60S 1/08

(52) U.S. Cl. CPC B60S 1/0844

(57) ABSTRACT

A precipitation level estimation system includes a calculation unit configured to: acquire detection data related to precipitation; and calculate a precipitation amount in a predetermined area included in an observation target area. The calculation unit is configured to: calculate a first feature in a first predetermined period based on first detection data acquired from a first area including the predetermined area, the first predetermined period being a period that is past with respect to present; calculate a second feature in a second predetermined period in a second area adjacent to the first area based on second detection data acquired in the second area, the second predetermined period being a period that is past with respect to the first predetermined period; calculate the precipitation amount using a precipitation amount estimation model using the first feature and the second feature as variables; and calculate the precipitation amount based on the features.

### CROSS-REFERENCE TO RELATED APPLICATION

This application claims priority to Japanese Patent Application No. 2023-109917 filed on Jul. 4, 2023, incorporated herein by reference in its entirety.

### BACKGROUND

### 1. Technical Field

The present disclosure relates to a precipitation level estimation system and a storage medium that can estimate the precipitation amount.

### 2. Description of Related Art

In recent years, awareness of disaster prevention against localized heavy rains has increased. Japanese Unexamined Patent Application Publication No. 2020-052962 (JP 2020-052962 A) describes a technique for calculating an index indicating the intensity of precipitation in an area including vehicles based on data related to the operation modes of wiper devices of the vehicles.

### SUMMARY

Wipers have three operation modes, for example, low, medium, and high. According to the technique described in JP 2020-052962 A, the intensity of precipitation is estimated based on data related to the operation modes of the wipers. Particularly during intense precipitation, the operation mode of the wiper is fixed to high, and therefore the operation mode of the wiper correlates less with the precipitation amount. Accordingly, it may be difficult to accurately estimate the precipitation level in a certain area by the technique described in JP 2020-052962 A.

It is an object of the present disclosure to provide a precipitation level estimation system and a storage medium that can accurately calculate a precipitation level using an estimation method based on machine learning using data related to precipitation acquired from vehicles.

A precipitation level estimation system according to an aspect of the present disclosure includes a calculation unit configured to
acquire detection data related to precipitation, the detection data being data detected by a plurality of vehicles that is present in an observation target area, and
calculate a precipitation amount in a predetermined area included in the observation target area based on the detection data.

The calculation unit is configured to
calculate a first feature in a first predetermined period based on first detection data acquired from a first area including the predetermined area, the first predetermined period being a period that is past with respect to present,
calculate a second feature in a second predetermined period in a second area adjacent to the first area based on second detection data acquired in the second area, the second predetermined period being a period that is past with respect to the first predetermined period, calculate the precipitation amount using a precipitation amount estimation model using the first feature and the second feature as variables, and
calculate a precipitation level according to the precipitation amount.

According to the present disclosure, it is possible to accurately calculate a precipitation level using an estimation method based on machine learning using data related to precipitation acquired from vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a precipitation level estimation system according to an embodiment;

FIG. 2 is a diagram illustrating an observation method in an observation target area;

FIG. 3 is a diagram illustrating a predetermined area in an observation target area;

FIG. 4 is a diagram illustrating contents of a plurality of features;

FIG. 5 is a diagram showing mapping data in which precipitation levels are displayed;

FIG. 6 is a graph showing a change in precipitation level with time in the mapped data. and

FIG. 7 is a flowchart illustrating a flow of processing of the precipitation level estimation method.

### DETAILED DESCRIPTION OF EMBODIMENTS

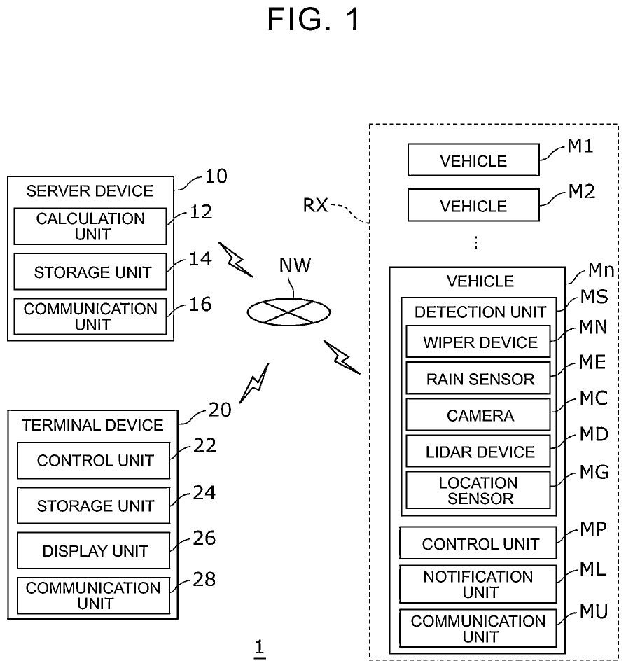

As illustrated in FIG. 1, the precipitation level estimation system 1 includes a server device 10 connected to a network NW and a plurality of vehicle Mn (n: any natural number). The plurality of vehicles Mn exist in the observation target area RX to be observed. The observation target area RX is set to, for example, a rectangular area having a predetermined area. The server device 10 communicates with a plurality of vehicle Mn and acquires detection data related to precipitation. The server device 10 calculates the precipitation level in the observation target area RX based on the detection data.

For example, there are herein three precipitation levels according to the precipitation amount as described later. The server device 10 provides information including the precipitation level to Mn of vehicles in the observation target area RX based on the calculation result. The server device 10 may also provide information to the terminal device 20 connected to the network NW in addition to the vehicle Mn.

The terminal device 20 includes, for example, an information processing terminal device such as a personal computer or a smartphone. The terminal device 20 includes, for example, a display unit 26 that displays information. The display unit 26 includes, for example, a display device such as a liquid crystal display. The terminal device 20 includes a communication unit 28 capable of communicating with a network NW. The communication unit 28 includes communication interfaces connectable to a network NW. The terminal device 20 includes a control unit 22 that executes communication and information display processing.

The terminal device 20 includes a storage unit 24 in which data and programs necessary for control are stored. The control unit 22 is constituted by a hardware processor such as at least one Central Processing Unit (CPU). The storage unit 24 includes a non-transitory storage medium such as a hard disk drive (HDD) or a solid state disk (SSD).

The server device 10 includes a calculation unit 12 that performs various arithmetic processing, a storage unit 14 that stores data and programs required for the arithmetic processing, and a communication unit 16 that communicates with the network NW. The calculation unit 12 includes at least one hardware processor such as a CPU. The storage unit 14 is constituted by a non-transitory storage medium such as a hard disk drive or a solid state disk. The communication unit 16 includes communication interfaces connectable to a network NW.

The calculation unit 12 acquires detection data related to precipitation detected by a plurality of vehicles Mn existing in the observation target area RX. The calculation unit 12 calculates the precipitation amount of the observation target area RX based on the detection data. The contents of the arithmetic processing of the calculation unit 12 will be described later. The calculation unit 12 calculates a precipitation level distribution in the observation target area RX based on the calculation result. The calculation unit 12 provides information on the precipitation amount to the vehicles Mn used by the users via the network NW.

The vehicle Mn is configured to communicate with the server device 10 via a network NW. The vehicle Mn includes, for example, a detecting unit MS that detects various types of data. The detecting unit MS is constituted by a plurality of apparatuses, sensors, and the like provided in the vehicle Mn. The detecting unit MS is configured by a vehicle device capable of acquiring a control signal required for control, a current required for operation, and data required for controlling the vehicle Mn. The detecting unit MS includes, for example, a wiper device MN that wipes windows on Mn of vehicles.

The wiper device MN is provided in a front window or a rear window of the vehicle Mn. The wiper device MN operates in three operation modes, e.g., low, medium, high. In the operation mode, the operation speed increases in the order of low, medium, and high. The operating speed is set by, for example, the number of wipes per unit time (number of wipes/minute). The operation mode may be provided with a speed adjustment mode in which the number of wipes per unit time can be arbitrarily adjusted. The wiper device MN operates based on an operation of an occupant of the vehicle Mn. The wiper device MN operates based on a control signal corresponding to an operation of the occupant. The control signal is set corresponding to the stepped operation mode or the speed adjustment mode.

The wiper device MN may be provided with a rain sensor ME for detecting rainfall. The rain sensor ME is provided inside the front window and detects a change in the light transmittance of the front window. The wiper device MN is activated automatically, for example, when rain is detected by the rain sensor ME. The wiper device MN operates by automatically setting the operating mode in response to a change in the signal detected by the rain sensor ME.

The detecting unit MS is provided with a camera MC capable of capturing images. The camera MC captures an image of an external environment of the vehicle Mn. Image data captured by the camera MC is used, for example, to control the vehicle Mn. The detecting unit MS is provided with a LiDAR device MD that emits a laser-wave. LiDAR device MD receives a reflected wave of the emitted laser wave and detects an object existing around the vehicle Mn. The detecting unit MS is provided with a location sensor MG for detecting the present location of the vehicle Mn. The location sensor MG includes, for example, a Global Positioning System (GPS) sensor.

The vehicle Mn is provided with a control unit MP for executing various controls. The control unit MP executes control related to traveling of the vehicle Mn. The control unit MP transmits data related to precipitation among the data detected by the detecting unit MS to the server device 10. The control unit MP includes at least one hardware processor such as a CPU.

The vehicle Mn is provided with a notification unit ML for notifying various types of information. The notification unit ML includes, for example, a display device capable of displaying images including notification content in the notification unit ML. The notification unit ML may be configured by a speaker that outputs a notification content by sound. The vehicle Mn includes a communication unit MU connectable to a network NW. The communication unit MU includes, for example, communication interfaces capable of performing radio communication.

The vehicle Mn acquires various types of information by the detecting unit MS during traveling. The control unit MP controls the traveling of the vehicle Mn based on the acquired information. The control unit MP transmits data related to precipitation among the data acquired by the detecting unit MS to the server device 10. The control unit MP transmits, for example, data related to the control of the wiper device MN to the server device 10. In the server device 10, data is stored in the storage unit 14. The calculation unit 12 calculates the precipitation amount in the observation target area RX based on the data stored in the storage unit 14.

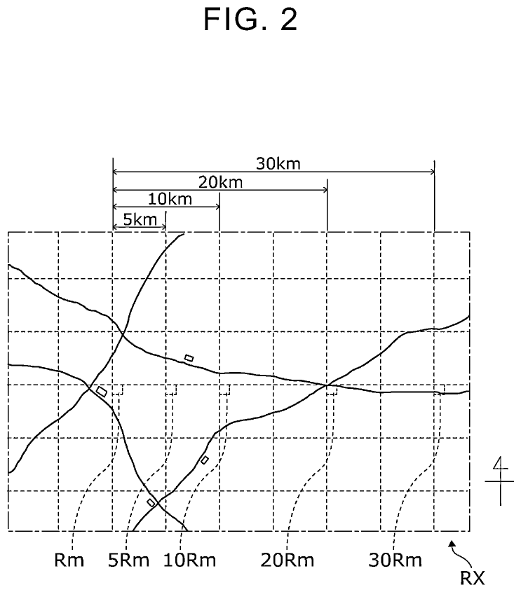

As illustrated in FIG. 2, the map-data of the observation target area RX includes an area Rm (m: natural number). The area Rm is set to, for example, a rectangular area of 1 km square. The size, location, and shape of the area Rm are arbitrarily set. In the area Rm, ID number is set corresponding to the location. The area Rm is managed by the server device 10. The server device 10 communicates with a plurality of vehicles Mn existing in the observation target area RX. In the server device 10, the calculation unit 12 acquires the location data of the vehicle Mn and ID data for identifying the vehicle Mn.

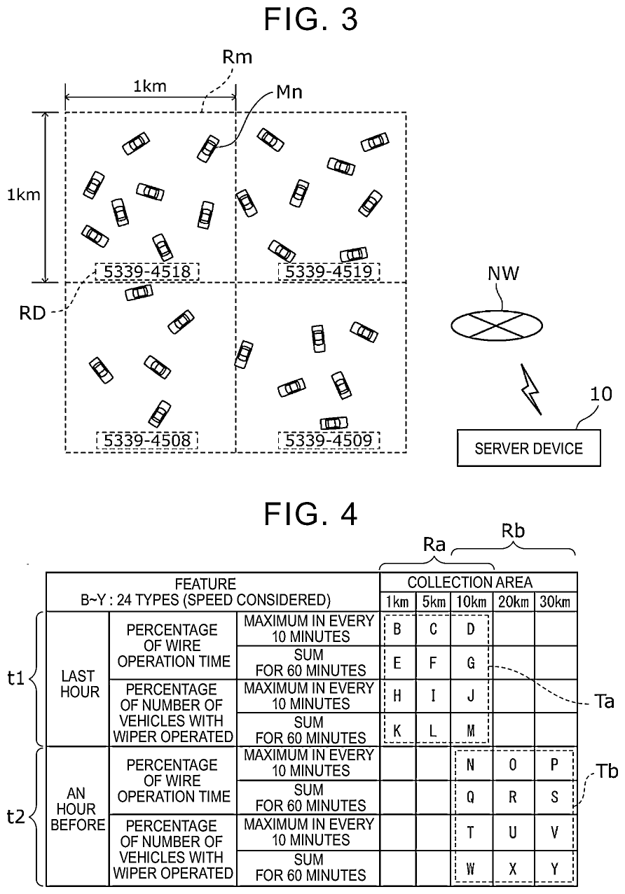

As illustrated in FIG. 3, the calculation unit 12 compares ID data RD of the area Rm with the data acquired from the vehicle Mn, and recognizes the vehicle Mn existing in the area Rm. The calculation unit 12 acquires detection data related to precipitation from a plurality of Mn of vehicles existing in the area Rm. The detection data related to precipitation includes, for example, data related to the operation status of the wiper device MN, vehicle ID data, vehicle location data, time data, and the like. The calculation unit 12 acquires detection data from Mn of vehicles existing in the area Rm at every predetermined cycle (e.g., cycle of one minute). The calculation unit 12 stores the acquired detection data in the storage unit 14.

The calculation unit 12 calculates the precipitation amount in the area Rm. The area Rm includes a user location where a user who receives information about precipitation from the server device 10 exists. The location of the user is provided to the server device 10 via the vehicle Mn that is currently riding or the terminal device 20 that is in possession. The calculation unit 12 calculates the precipitation amount in the area Rm including the user location based on the location information provided from the user.

As illustrated in FIG. 4, the calculation unit 12 generates Y from the plurality of features B used for estimating the precipitation amount every predetermined cycle (for example, every 10 minute cycle) based on the detection data. The plurality of features B to Y are classified into 24 types of elements such as a velocity component, a temporal component, a vehicle Mn number component, and an area component of the wiper device MN, for example. The plurality of features B to Y are set so that the feature appears in the calculation of the precipitation amount at the user location on the basis of the data indicating the operation status of the wiper device MN.

For example, the calculation unit 12 generates the first feature Ta (M from the feature B) based on the first detection data acquired from the first area Ra included in the observation target area RX. The first area Ra is set by, for example, a plurality of sample data collection areas including a user location and a surrounding point thereof. The plurality of sample-data collection areas is set by, for example, a 1 km by 1 km area Rm including a user location and a plurality of 1 km by 1 km peripheral areas including a peripheral point spaced apart from the user location by a predetermined distance.

The peripheral point includes, for example, a point 5 km away from the user location and a point 10 km away from the user location. The calculation unit 12 collects the first detection data of the first area Ra including the user location and the peripheral point in any direction from the user location. The direction in which the data is collected is arbitrarily set based on the collection method of the sample data. The calculation unit 12 collects, for example, data of the first area Ra in four directions of east, west, south, and north from the user location. The calculation unit 12 may collect data of the first area including any direction elements such as an eight azimuth directions in which northeast, northwest, southwest, southwest, and southeast directions are added in the cast, west, south, and north directions.

The calculation unit 12 acquires the first detection data of the first area Ra in the first predetermined period t1 that is past with respect to the present. The first predetermined period t1 is, for example, one hour before the present time. For example, the calculation unit 12 generates M from the feature B in four azimuths based on the first detection data acquired in the first area Ra. For example, the calculation unit 12 generates M from the feature B on the basis of wiper operation data indicating an operating state of the wiper device provided in the vehicle.

The calculation unit 12 calculates, for example, a feature related to the percentage of wiper operation time indicating the operating state of the wiper device MN. The percentage of wiper operation time is the percentage of the time during which the wiper device is in operation per predetermined period. The percentage of wiper operation time includes features B, C, D calculated by the maximal time when the wiper device is operated for each predetermined period (for example, 10 minutes) and features E, F, G calculated by the sum of the times during which the wiper device was in operation for the predetermined period (for example, 60 minutes).

A total of six features B, C, D indicating precipitation levels are sampled during one hour at every 10-minute aggregation interval. Features B, C, D can be sampled briefly and precipitation peaks indicative of intense precipitation can be accurately captured by utilizing their maxima for one hour and a feature E, F, G indicative of the summation for one hour of the time the wiper device is activated.

The feature B and the feature E are calculated in 1 km square rectangular area including the user location. The feature C and the feature F are calculated in a rectangular area 5Rm (see FIG. 2) of 1 km square including a point 5 km separated from the user location in a predetermined direction. The feature D and the feature G are calculated in a rectangular area 10Rm (see FIG. 2) of 1 km square including a point 10 km separated from the user location in a predetermined direction.

In the first area Ra, the above-described feature indicating the precipitation level is calculated not only in the 1 km square of the area Rm including the user location but also in the area 5Rm, 10Rm spaced apart from each other in the four directions around the area Rm. The number of Mn of vehicles that can collect data increases as the area of the sampling point to be used as the basis of the calculation of the feature increases. Further, by performing sampling according to the direction, it is possible to capture the precipitation tendency.

The calculation unit 12 calculates, for example, the percentage of the number of vehicles with the wiper device operated that indicates the operating state of the wiper devices. The percentage of the number of vehicles with the wiper device operated is features H, I, J calculated based on the largest number of vehicle Mn in which the wiper device is operated in each predetermined period (for example, 10 minutes), and features K, L, M calculated based on the sum of the number of vehicle Mn in which the wiper device is operated in the predetermined period (for example, 60 minutes).

For example, if all the vehicles Mn are operating 10% of the travel time at a wiper speed (e.g., 50 times/min), the feature of the percentage of wiper operation time is calculated to be 10%. In this case, since the wiper device has been operated in all the vehicles Mn for 60 minutes, the feature of the percentage of the number of vehicles with the wiper device operated is calculated to be 100%.

In the calculation of the feature, by calculating the percentage of operation [%] instead of the frequency at which the wiper device MN is operated, it is possible to suppress the variation in the calculated value caused by the difference in the number of traveling vehicles of Mn existing in the area to be calculated. By calculating the feature related to the percentage of wiper operation time, it is possible to easily capture intense precipitation. In the calculation of the feature, in addition to the viewpoint of the “time”, the viewpoint of the “number” can also be used, so that it is possible to easily capture intense precipitation.

For example, the calculation unit 12 generates the second feature Tb (features N to Y) on the basis of the second detection data acquired from the second area Rb adjacent to the first area Ra included in the observation target area RX. The second area Rb is set by, for example, a plurality of data-collection areas including neighboring points adjacent to the first area Ra. The plurality of data-collection areas is set by, for example, rectangular areas of 1 km square including peripheral points spaced apart from the user location by a predetermined distance. The peripheral point includes, for example, a point that is 10 km separated from the user location in a predetermined direction, a point that is 20 km separated from the user location, and a point that is 30 km separated from the user location in a predetermined direction.

In the second area Rb, the feature indicating the precipitation level is calculated in the areas 10Rm, 20Rm, 30Rm separated from each other in four directions around the area Rm. The number of Mn of vehicles that can collect data increases as the area of the sampling point to be used as the basis of the calculation of the feature increases. In addition, the precipitation tendency can be captured by sampling the area Rm in a direction-dependent manner.

For example, the calculation unit 12 collects the second detection data of the second area Rb from the user location. The calculation unit 12 acquires the second detection data of the second area Rb in the second predetermined period t2 that is past with respect to the first predetermined period t1. The second predetermined period t2 is, for example, one hour before the starting time of the first predetermined period t1. For example, the calculation unit 12 generates Y from the features N in four azimuths based on the second detection data acquired in the second area Rb. For example, the calculation unit 12 generates Y from the features N on the basis of wiper operation data indicating the operating state of the wiper device provided in the vehicle.

The calculation unit 12 calculates, for example, the percentage of wiper operation time indicating the operating state of the wiper device MN. The percentage of wiper operation time includes a feature N, O, P calculated based on the maximal time at which the wiper device MN is operated every predetermined period (for example, 10 minutes) and features Q, R, S calculated based on the sum of the times during which the wiper device MN is operated during the predetermined period (for example, 60 minutes).

The feature N and the feature Q are calculated in a rectangular area 10Rm (see FIG. 2) of 1 km square including a point 10 km separated from the user location. The feature O and the feature R are calculated in a rectangular area 20Rm (see FIG. 2) of 1 km square including a point 20 km separated from the user location. The feature P and the feature S are calculated in a rectangular area 30Rm (see FIG. 2) of 1 km square including a point 30 km separated from the user location.

The calculation unit 12 calculates, for example, the percentage of the number of vehicles with the wiper device operated that indicates the operating state of the wiper device MN. The percentage of the number of vehicles with the wiper device operated includes features T, U, V calculated based on the largest number of vehicle Mn in which the wiper device is operated in each predetermined period (for example, 10 minutes), and features W, X, Y calculated based on the sum of the number of vehicle Mn in which the wiper device is operated in the predetermined period (for example, 60 minutes). The calculation unit 12 calculates a feature including the first feature Ta and the second feature Tb from the user location in four directions.

As described above, the first feature Ta in the first area Ra including the user location is calculated in the latest first predetermined period t1. The second feature Tb in the second area Rb distant from the user location is calculated in the second predetermined period t2 that is past with respect to the first predetermined period t1. The calculation unit 12 inputs the calculated first feature and the calculated second feature into a preset precipitation amount estimation model, and calculates a precipitation amount in the future from the present in the first area Ra included in the observation target area RX.

The precipitation amount estimation model is set by, for example, a nonlinear regression equation of a polynomial that calculates an estimation value of the precipitation amount of the area Rm including the user location using a plurality of features as variables. The nonlinear regression equation is arbitrarily set to a function capable of calculating the precipitation amount. The relationship between the precipitation amount and the feature related to the operating state of the wiper device MN gradually changes from a linear relationship to a curvilinear relationship. Therefore, the precipitation amount estimation model using nonlinear regression makes it possible to more accurately reproduce the different trends between high and low precipitation levels.

In the precipitation amount estimation model, a plurality of parameters corresponding to a polynomial including a plurality of features are set based on machine learning performed in advance in the calculation unit 12. The calculation unit 12 repeatedly executes machine learning by deep learning using a neural network, for example.

The calculation unit 12 uses the feature calculated based on the past detection data as the teacher data, and adjusts the parameter set in the precipitation amount estimation model by repeatedly executing machine learning for calculating an estimated value of the precipitation amount based on the feature. The estimated value of the precipitation amount is calculated by inputting the feature calculated using the detection data into the precipitation amount estimation model in which the parameter is adjusted. The precipitation amount estimation model in which the parameters are adjusted is stored in the storage unit 14 as a computer program. The calculation unit 12 calculates the precipitation amount at an arbitrary point by inputting the feature calculated using the detection data to the precipitation amount estimation model.

The calculation unit 12 acquires detection data related to precipitation detected by a plurality of vehicles Mn existing in the observation target area RX. The calculation unit 12 calculates the current to future precipitation amounts in the predetermined area included in the observation target area RX based on the detection data.

The calculation unit 12 calculates, for example, a plurality of first feature Ta in the first predetermined period t1 that is past with respect to the present, based on the first detection data acquired from the first area Ra. The calculation unit 12 calculates, for example, the second feature Tb in the second predetermined period t2 that is past with respect to the first predetermined period in the second area Rb, based on the second detection data acquired in the second area Rb adjacent to the first area Ra. The calculation unit 12 calculates a feature including a first feature Ta related to the percentage of the time during which the wiper device MN is operated and a second feature Tb related to the percentage of the number of vehicles whose wiper device is operated, based on wiper operation data indicating the operating state of the wiper device MN provided on the vehicle Mn out of the detection data.

The calculation unit 12 calculates the present precipitation amount in the area Rm using the precipitation amount estimation model in which the first feature Ta and the second feature Tb are set as variables. The calculation unit 12 compares the precipitation level set according to the precipitation amount with the calculated value of the precipitation amount, and calculates the precipitation level in the area Rm. For example, the calculation unit 12 determines the following three precipitation levels based on a comparison result with a predetermined reference precipitation amount.

When the precipitation amount is equal to or greater than the preset first precipitation amount V1 (for example, 20 mm/h), the calculation unit 12 determines that the precipitation amount is “high precipitation level (High)”. High precipitation level is set to the precipitation amount equal to or greater a reference that requires attention (e.g., 20 mm/h). The reference is set to any precipitation amount. When the precipitation amount is less than the first precipitation amount V1 and is equal to or greater than a preset second precipitation amount V2 (for example, 1 mm/h), the calculation unit 12 determines that the precipitation amount is “low precipitation level (Mid)”. When the precipitation amount is less than the second precipitation amount V2 (1 mm/h), the calculation unit 12 determines that “no precipitation (Low)” is obtained.

The calculation unit 12 may calculate the precipitation level in all other area Rm in the observation target area RX by repeatedly executing the same calculation process as described above as well as the precipitation level in the area Rm including the user location. The calculation unit 12 may generate the mapping data of the observation target area RX divided by the rectangular area of an arbitrary size by calculating one area Rm included in the rectangular area of an arbitrary size in the observation target area RX as a representative value, without necessarily calculating all other area Rm in the observation target area RX.

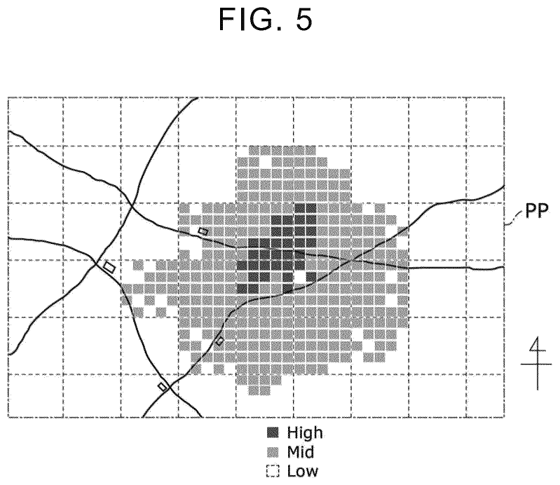

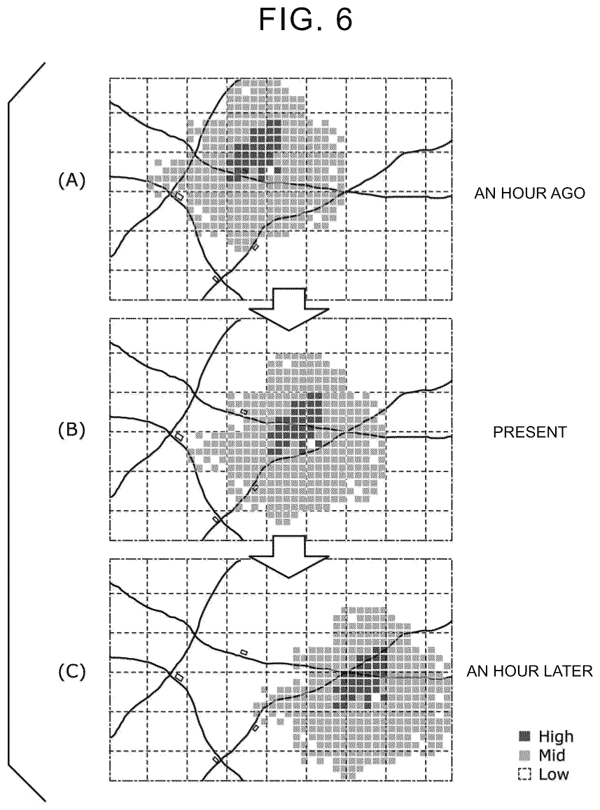

As illustrated in FIG. 5, the calculation unit 12 may generate a mapping data PP in which the precipitation level is mapped for each area Rm in the observation target area RX. As shown, in the mapping data PP, the distribution of areas of present high precipitation level (High), the distribution of areas of low precipitation level (Mid), and the distribution of areas of no precipitation (Low) are shown.

The precipitation amount estimation model may be configured to calculate not only the current precipitation amount but also the future precipitation amount by repeatedly executing machine learning based on past detection data. Therefore, the calculation unit 12 may calculate past and future precipitation levels in the area Rm based on the precipitation amount estimation model. The calculation unit 12 may calculate, for example, a precipitation amount before a predetermined time, a present precipitation amount, and a precipitation amount after a predetermined time in the area Rm including the user location. The calculation unit 12 may calculate the past, present, and future precipitation amounts at any time intervals. The calculation unit 12 may update the precipitation level estimation model at a predetermined timing using the accumulated detection data.

In general, an intense precipitation phenomenon often moves from a distant place into a large mass in conjunction with the movement of rain clouds. Therefore, in addition to calculating the first feature Ta in the first predetermined period t1, it is possible to calculate the tendency of precipitation to move by calculating the second feature Tb in the second predetermined period t2.

The calculation unit 12 may extract, based on the generated mapping data, area Rm of the observation target area RX having a high precipitation level at which the precipitation amount is equal to or greater than a reference value, and provide the user existing in the area Rm with information on the precipitation amount. The calculation unit 12 may cause the notification unit ML of the vehicle Mn on which the user in the extracted area Rm is boarding to notify the user of the predetermined information indicating the high precipitation level via the network NW. The calculation unit 12 may be configured to extract the area Rm that will have a high precipitation level during a future predetermined period, and provide the user who is present in the area Rm with information on the precipitation amount. The predetermined time in the future may be arbitrarily set.

The vehicle Mn may perform travel control corresponding to rainfall based on the provided predetermined information. The traveling control corresponding to the rainfall may be applied to Mn of vehicles traveling based on the automated driving. The traveling control corresponding to the rainfall may be the traveling assistance of the vehicle Mn traveling based on the manual driving. The calculation unit 12 may cause the display unit 26 of the terminal device 20 of the user to display predetermined information regarding the first precipitation level via the network NW.

The display unit 26 displays, for example, information related to the state of rainfall at a high precipitation level and information indicating that precipitation amount at a high precipitation level is approaching. The terminal device 20 of the user does not necessarily have to exist in the extracted area Rm. The user may be a user of a service that is provided with information on precipitation level.

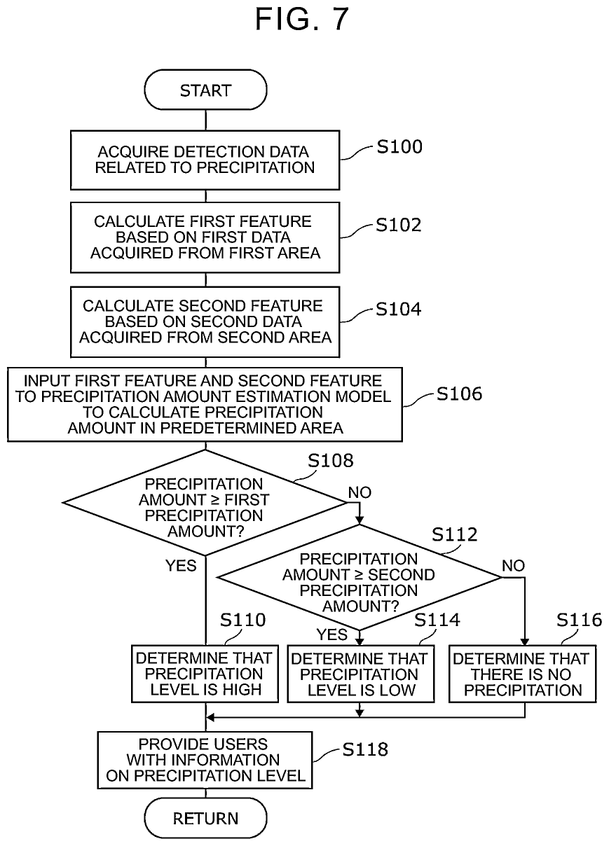

FIG. 7 is a flowchart showing the flow of the treatment of the precipitation level estimation method executed in the precipitation level estimation system 1. The precipitation level estimation method is processed based on a program installed in a computer constituting the precipitation level estimation system 1. The program causes the computer to perform the following steps related to the precipitation level estimation method.

The calculation unit 12 acquires detection data related to precipitation detected by a plurality of vehicles existing in the observation target area (S100). The calculation unit 12 calculates the first feature in the first predetermined period that is past with respect to the present, based on the first detection data acquired from the first area Ra included in the observation target area RX (S102). The calculation unit 12 calculates the second feature in the second predetermined period t2 that is past with respect to the first predetermined period t1 in the second area Rb based on the second detection data acquired in the second area Rb adjacent to the first area Ra (S104).

The calculation unit 12 calculates a precipitation amount in a predetermined area Rm included in the observation target area RX by using a precipitation amount estimation model in which the first feature Ta and the second feature Tb are set as variables (S106). The calculation unit 12 determines whether or not the precipitation amount is equal to or greater than the first precipitation amount V1 (S108). When the precipitation amount is equal to or greater than the first precipitation amount V1, the calculation unit 12 determines that the precipitation amount is “high precipitation level” (S110).

When the precipitation amount is less than the first precipitation amount V1, the calculation unit 12 determines whether or not the precipitation amount is equal to or greater than the second precipitation amount V2 (S112). When the precipitation amount is equal to or greater than the second precipitation amount V2, the calculation unit 12 determines that the precipitation amount is “weak precipitation level” (S114). When the precipitation amount is less than the second precipitation amount V2, the calculation unit 12 determines that “no precipitation” is present (S116). The calculation unit 12 provides information on the precipitation level to the user who is present in the area having the high precipitation level (S118).

As described above, according to the precipitation level estimation system 1, it is possible to accurately estimate the precipitation level by calculating a plurality of features based on the detection data related to the operating state of the wiper device MN. According to the precipitation level estimation system 1, it is possible to accurately estimate the precipitation level by inputting a plurality of features to a precipitation amount estimation model in which parameters are adjusted based on machine learning. According to the precipitation level estimation system 1, it is possible to accurately estimate the precipitation level by using the nonlinear regression in the precipitation amount estimation model.

In the above-described embodiment, the features are calculated based on the operating state of the wiper device MN. The feature may be calculated based on not only the detection data of the wiper device MN but also the detection data of the rain sensor ME, the imaging data of the surroundings of the vehicle Mn by the camera MC, and the detection data detected by LiDAR device MD. The feature may be calculated by the calculation unit 12 repeatedly executing the machine learning on the basis of the captured image data in which the state of rainfall is captured by the camera MC.

The feature may be calculated by the calculation unit 12 repeatedly executing the machine learning based on the rain detection data detected by the rain sensor ME. Since the detection data of LiDAR device MD is deteriorated due to the generation of rainfall, the feature may be calculated by the calculation unit 12 repeatedly executing the machine learning based on the detection data of LiDAR device MD. The feature may be calculated by combining one or more pieces of detection data from the wiper device MN, the camera MC, and the rain sensor ME, LiDAR device MD. The feature may be calculated using any kind of detection data related to precipitation as long as the detection data can be detected.

The computer program executed in each configuration of the precipitation level estimation system 1 may be provided in a form recorded on a computer-readable portable recording medium (a storage medium) such as a semiconductor memory, a magnetic recording medium, or an optical recording medium.

What is claimed is:

1. A precipitation level estimation system comprising a calculation unit configured to
acquire detection data related to precipitation, the detection data being data detected by a plurality of vehicles that is present in an observation target area, and
calculate a precipitation amount in a predetermined area included in the observation target area based on the detection data, wherein the calculation unit is configured to
calculate a first feature in a first predetermined period based on first detection data acquired from a first area including the predetermined area, the first predetermined period being a period that is past with respect to present,
calculate a second feature in a second predetermined period in a second area adjacent to the first area based on second detection data acquired in the second area, the second predetermined period being a period that is past with respect to the first predetermined period,
calculate the precipitation amount using a precipitation amount estimation model using the first feature and the second feature as variables, and
calculate a precipitation level according to the precipitation amount.

2. The precipitation level estimation system according to claim 1, wherein the calculation unit is configured to
calculate features including the first feature related to a percentage of time during which a wiper device was in operation and the second feature related to a percentage of the number of vehicles whose wiper device was operated, based on wiper operation data indicating an operating state of the wiper devices provided in the vehicles out of the detection data, and
calculate the precipitation amount based on the features.

3. The precipitation level estimation system according to claim 1, wherein the calculation unit is configured to
calculate the precipitation level in the area, and
generate mapping data in which the precipitation level is mapped for each of a plurality of the areas in the observation target area.

4. The precipitation level estimation system according to claim 3, wherein the calculation unit is configured to
extract from the observation target area the area with such a precipitation level that the precipitation amount is equal to or greater than a reference, based on the mapping data, and
provide information on the precipitation level to a user who is present in the area.

5. A non-transitory storage medium storing a program that causes a computer to execute:
acquiring detection data related to precipitation, the detection data being data detected by a plurality of vehicles that is present in an observation target area;
calculating a first feature in a first predetermined period based on first detection data acquired from a first area included in the observation target area, the first predetermined period being a period that is past with respect to present;
calculating a second feature in a second predetermined period in a second area adjacent to the first area based on second detection data acquired in the second area, the second predetermined period being a period that is past with respect to the first predetermined period; and
calculating a precipitation amount in a predetermined area included in the observation target area using a precipitation amount estimation model using the first feature and the second feature as variables, and calculating a precipitation level according to the precipitation amount.
